(19) United States
(12) Patent Application Publication
(10) Pub. No.: US 2010/0193052 A1
(43) Pub. Date: Aug. 5, 2010

(54) Motorised Water Butt Modular System

(76) Inventor: Cedric B. Watkins, Worcestershire (GB)

Correspondence Address: ICE MILLER LLP, ONE AMERICAN SQUARE, SUITE 3100, INDIANAPOLIS, IN, 46282-0200, US

(21) Appl. No.: 12/226,568

(22) PCT Filed: Apr. 23, 2007
(86) PCT No.: PCT/GB2007/001466

§ 371 Date: Mar. 23, 2010

(30) Foreign Application Priority Data
Apr. 21, 2006 (GB) 0607963.6

(51) Int. Cl. E03B 3/03; G05D 7/06; G05D 16/20

(52) U.S. Cl. 137/565.01; 700/282; 137/602

(57) ABSTRACT

A water butt system comprising:
a main distribution butt having a base and a sidewall to define a container, a first opening in said sidewall to receive an outlet and at least one further opening in said sidewall which receives a fluid connection;
at least one additional storage butt having a base and a sidewall to define a container, and at least one opening in said sidewall which receives said connection;
a further opening in at least one of said main distribution butt and said at least one additional storage butt to receive an inlet;
wherein the base of said main distribution butt is at substantially the same level as the base of said at least one additional storage butt;
and said at least one further opening of said main distribution butt and said at least one opening in said sidewall of said at least one additional storage butt which receive said connection are proximate to, and at substantially the same height above, the respective bases of the butts so as to allow said distribution butt and said at least one additional storage butt to fill and empty at substantially the same rate,
and wherein said openings receiving said inlet and said outlet are also at substantially the same level as said connection.

The invention relates to a system of connecting water butts.

More specifically, the invention relates to a system of connecting any number of modular water butts together for increased water storage capacity. The invention is particularly applicable to the DIY market, in that the system requires very few tools for connection, and the system also offers a number of connection options which allow the system to be fitted into virtually any size or shaped garden or space.

Water storage systems comprising water butts are well known.

An example of a water distribution system consists of a hose pipe connected to a water butt in the garden. The problem with such an arrangement is that due to the elongated shape of the water butt, the variation in the height of water inside the water butt causes significant variation in the pressure on the head of water in the water butt. Consequently, when the level of water in the water butt is low, the head of water does not generate sufficient pressure to distribute the water in the bottom of the water butt effectively.

Another type of water distribution system consists of a number of separate water butts connected in series, including a pump to generate the necessary pressure to distribute the water effectively. A disadvantage of a water distribution system of this type is that the water butts are slaved together, meaning that the water butts cannot be separated from each other, which prevents the user from modifying the layout of the water butts to fit the space available. Water butt systems of this type are typically located underground, which further limits the design of the butt with respect to its inlets and outlets.

An aim of the invention is to provide an improved water butt system.

According to the invention there is provided a water butt system comprising:
a main distribution butt having a base and a sidewall to define a container, a first opening in said sidewall to define an outlet and at least one further opening in said sidewall for receiving a connection;
at least one additional storage butt having a base and a sidewall to define a container, and at least one opening in said sidewall for receiving said connection;
a further opening in at least one of said main distribution butt and said at least one additional storage butt defining an inlet; wherein the base of said main distribution butt is at substantially the same level as the base of said at least one additional storage butt, and said openings for receiving said connection are proximate to and substantially the same height above said bases so as to allow said distribution butt and said at least one additional storage butt to fill and empty at the same rate, and wherein said openings defining said inlet and said outlet are also at substantially the same level as said connection.

By having the connection situated close to the base of each butt, as the inlet butt fills the water will follow the path of least resistance and flow into any adjoining butts, so the water butts will fill and empty at the same rate. At any one time, and provided all connections are open, each water butt in the system therefore contains the same volume of water. This means that water can potentially be drawn from any butt in the system, which is particularly convenient for reducing the distance that a hosepipe needs to be trailed for example.

Preferably at least one water butt in the system has a water height gauge fitted to its external surface, so given that the water butts fill at the same rate the user can quickly and easily see how much water is present in the entire system simply by multiplying the volume of water in one butt by the number of butts in the system.

In a preferred embodiment, each water butt in the system has a number of openings comprising connector sockets which could for example be internally threaded hexagon brass nuts, integrally moulded into the wall of the water butt, and a number of these sockets are spaced around the circumference of each water butt. Connecting pipes are fitted to these sockets and in this manner a number of water butts can be connected to each other in a space efficient manner as part of a modular system.

In one embodiment the inserts are spaced ninety degrees apart from each other around the circumference of the water butt i.e. four inserts per butt, although depending on the size of butts used, these may be situated more closely so that more butts can be fitted into a given area.

Therefore in the preferred embodiment each water butt in the system comprises a number of circumferentially spaced openings each positioned at the same height around the circumference and each comprising a uniform connector socket. By virtue of their uniform nature each connector socket is capable of receiving an inlet pipe, an outlet pipe, or a connecting pipe. Therefore the basic design of each water butt in the system is essentially identical, with the function of each butt being defined by the connection made.

Any insert which is not connected to another water butt will be fitted with a stop plug to prevent loss of water.

In the preferred embodiment the water butts are connected by connecting pipes having a stop tap, which can prevent the flow of water from one butt to another. In this way, should the user want to isolate one of the water butts, for example should they want to remove it from the system, they can do so without having to drain every butt in the system first.

In the preferred embodiment, one of the butts comprises a water pump, this butt becoming the main distribution butt within the system. The pump is preferably powered by mains supply, although it may also be powered by a battery, the pump providing the necessary pressure to distribute water from the butts regardless of the level of water remaining. The pump also includes a float cut-off switch which prevents the pump from pumping and therefore overheating when there is no water left in the system. The pump also comprises control means to allow the user to adjust the pressure to the desired level.

Preferably the main distribution butt includes a multi-way distribution block connected to the outlet, so that a number of appliances can be connected to the system.

The system also preferably comprises a filter to prevent debris from polluting the system.

Preferably the water butts have a flat base and are manufactured from strengthened material so that they can be located directly on the ground without the need for a stand.

The system described above has many advantages which will clearly be appreciated by the DIY user. In particular, a first-time user of such a water butt system may initially buy two butts, one main distribution butt including a pump, and a second additional storage butt. If they decide in future that they require extra water butts, new ones can quickly and easily be added to the system. The system does not have to be restricted to having just one distribution butt either. The user can have as many distribution butts as required by connecting a suitable outlet e.g. a tap, and by connecting to a pump if pressurised water is required.

The system can also be easily adapted for more commercial purposes. This can be done by increasing the volume of each water butt and also supplying a more powerful pump. Given the ease with which additional water butts can be added to the system, the only restriction on the water capacity that can be stored is the amount of space available.

A water butt in accordance with the invention will now be described by way of example only with reference to the accompanying drawings, in which

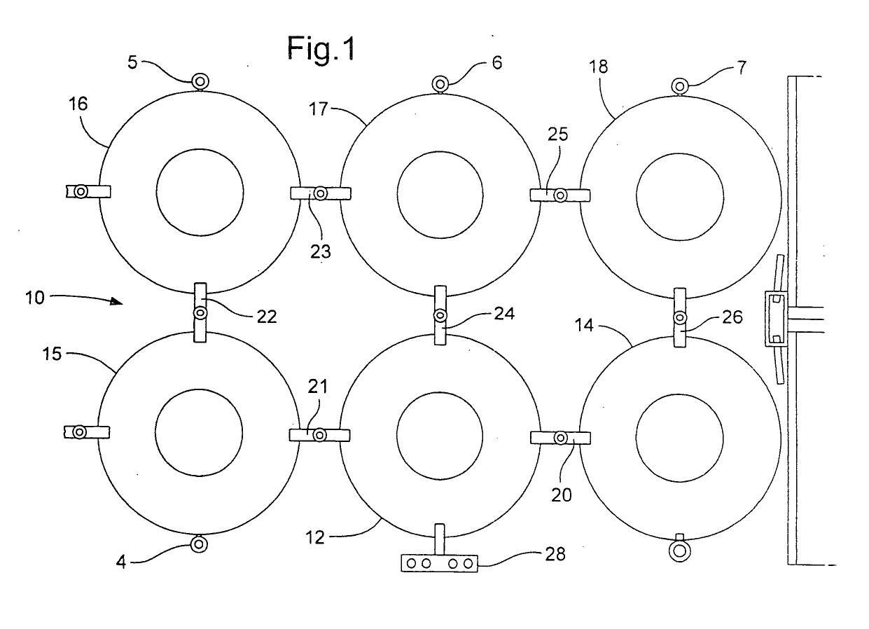

FIG. 1 is a plan view of one arrangement of a water butt system.

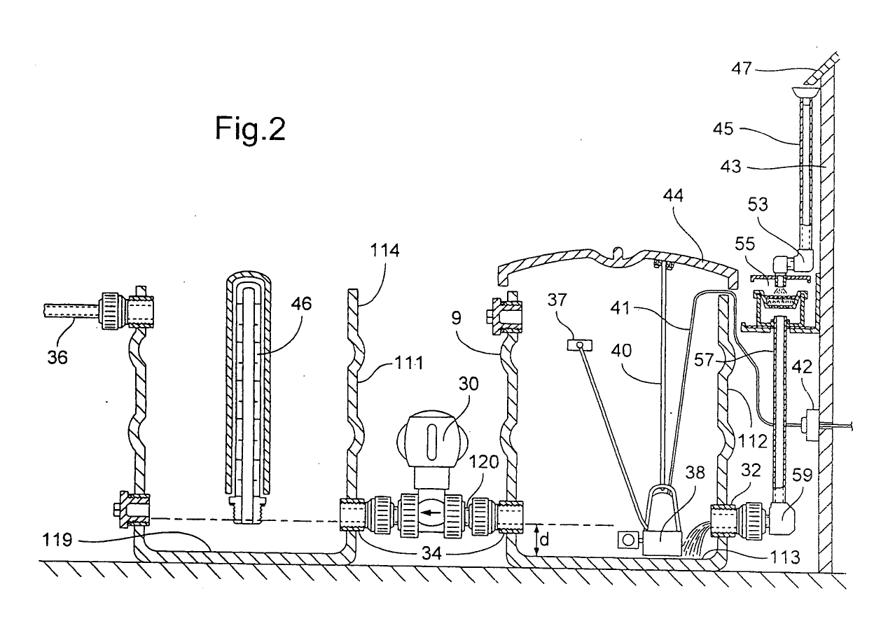

FIG. 2 is a side view in cross-section showing the connection between a distribution butt and a storage butt.

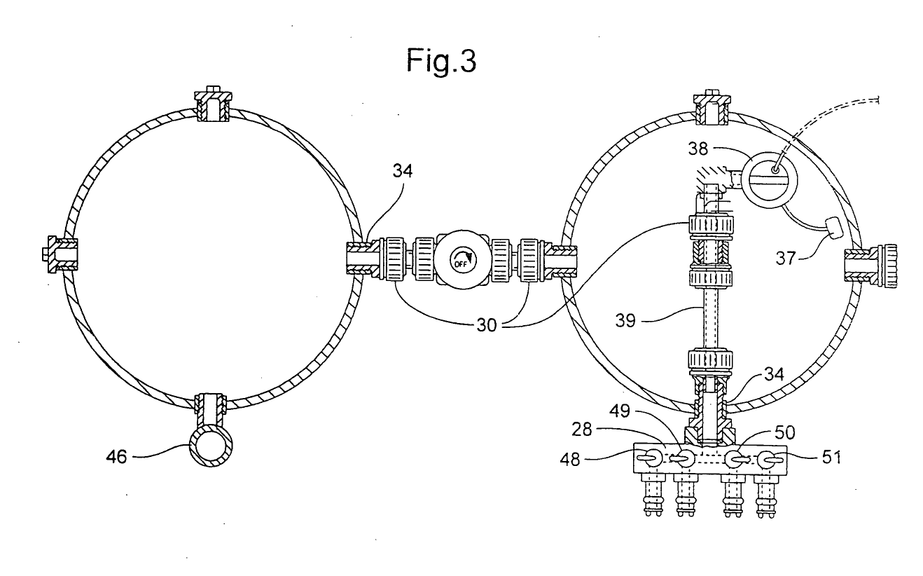

FIG. 3 is a plan view of FIG. 2.

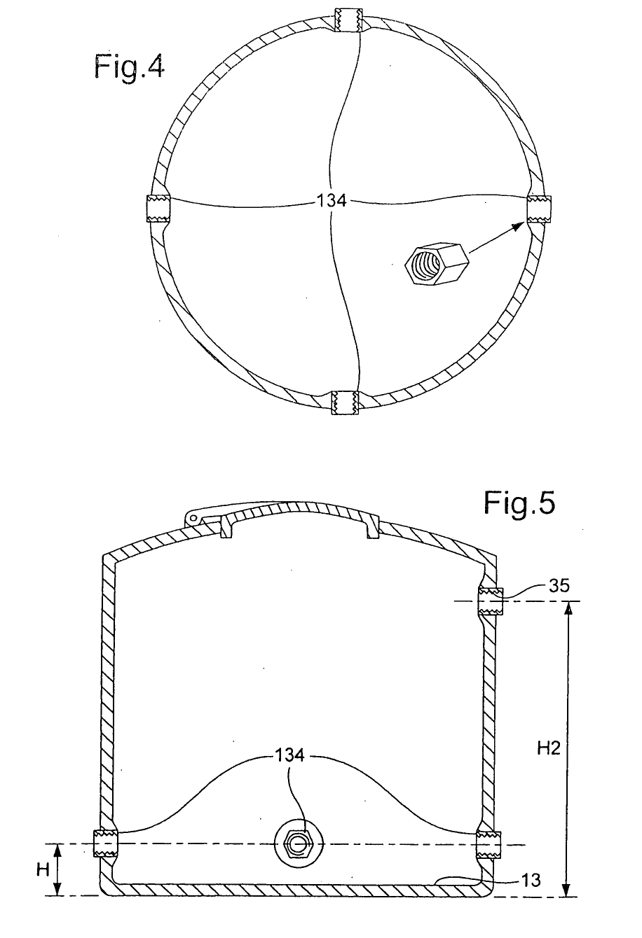

FIG. 4 is a plan view showing a possible arrangement for the positioning of the connector inserts.

FIG. 5 is a side view in cross-section of FIG. 4.

Referring to FIG. 1, a water butt system comprising six butts is shown. The system consists of main distribution butt 12 and further storage butts 14, 15, 16, 17 and 18. The storage butts are connected together by connecting pipes 20, 21, 22, 23, 24, 25 and 26.

A four-way distribution outlet 28 is shown connected to main distribution butt 12, which allows for connection to a hose pipe (not shown).

The storage butts 15 to 18 further comprise stop plugs 4, 5, 6 and 7 to prevent leakage.

The operation of the system is best appreciated by viewing FIG. 2, in which the system is connected to building 43.

During rainfall, rain runs from the roof 47 and into gutter 45. The rainwater then flows via adapter piece 53 into filter 55, the filtered water then flowing through down pipe 57 into the inlet 32 of main distribution butt 112 via ninety degree elbow connector 59. Main distribution butt 112 starts to fill independently of storage butt 114, until the depth of the water in main distribution butt 112 reaches a depth d at which water will begin to flow into the storage butt 114 through connecting pipe 120 by virtue of the open stop-tap 30. As rainwater continues to fall, and so long as the stop-tap 30 is in the open position as shown, the main distribution butt 112 and the storage butt 114 will continue to fill at the same rate.

The volume of water in the storage butt 114 can be easily ascertained by viewing the level shown on the water height gauge 46. Since the butts fill at the same rate, the total volume of water contained in the system shown can be easily calculated by multiplying the level shown on the water height gauge 46 by two.

Additional storage butt 114 is further fitted with overflow pipe 36 situated near the top of the butt, so that when both butts approach their capacity, any further rainwater will cause the water in the storage butt to flow via overflow pipe 36 to a soakaway (not shown).

The main distribution butt 112 further comprises a pump 38 which is housed within the butt and connected to mains power supply 42 via waterproof cable 41. The pump 38 is connected to a lid 44 of the butt by pump-lifting chain 40 which is secured to the underside of the lid. As well as connecting the pump-lifting chain to the pump, the lid 44 also prevents leaves and debris from entering the butt which could clog the system.

The main distribution butt 112 and the storage butt 114 have bases 113 and 119, and side walls 112 and 111 respectively. The bases and side walls are of a strengthened material, thus allowing the butts to be located directly on the ground without the need for a stand.

As seen in FIG. 3, a four-way distribution block 28 having taps 48, 49, 50 and 51 is connected to the main distribution butt 12 by threadedly engaging a uniform connector socket 34. The four-way distribution block 28 is connected to the pump 38 by connector 39. Pressurised water can therefore be supplied to the four-way distribution block 28, which can then outlet via any of the four taps. The pump 38 features a float cut-off switch 37 which prevents the pump from operating when the main distribution butt 112 is empty.

FIGS. 4 and 5 show the location of uniform connection sockets 134 which are in the form of hexagonal brass nuts. As shown in FIG. 4, these inserts, which are spaced ninety degrees apart around the circumference of the butt, are of identical construction. Each of the inserts has an internal thread to allow the connecting pipes, or stop-plugs to be screwed into the butts.

As seen in FIG. 5, the four connection inserts 134 are all located at the same vertical height, H, above ground level. This has the dual function of maximising compatibility between adjacent water butts, and also ensures that they fill and empty at the same rate. As also seen in FIG. 5, there is a fifth uniform connector socket 33, which is positioned at a height H2 above the ground and near to the top of the water butt. This connector, which also has an internal thread, allows for connection of the overflow pipe.

The water butt system has been described by way of example only, and it should be appreciated that various modifications are possible which still fall within the scope of the invention. For example, in FIGS. 2 and 3, a basic system consisting of a main distribution butt and one additional storage butt is shown, and in FIG. 1 a system consisting of one main distribution butt and five additional storage butt is shown. Clearly, any number of additional storage butts can be used, and for larger systems more than one distribution butt may be required. In FIGS. 1, 3 and 4, the uniform connectors are shown spaced ninety degrees apart, but it should be appreciated that other spacings are possible.

1. A water butt system comprising:
a main distribution butt having a base and a sidewall to define a container, a first opening in said sidewall to receive an outlet and at least one further opening in said sidewall which receives a fluid connection;
at least one additional storage butt having a base and a sidewall to define a container, and at least one opening in said sidewall which receives said connection;
a further opening in at least one of said main distribution butt and said at least one additional storage butt to receive an inlet;
wherein the base of said main distribution butt is at substantially the same level as the base of said at least one additional storage butt;
and said at least one further opening of said main distribution butt and said at least one opening in said sidewall of said at least one additional storage butt which receive said connection are proximate to and at substantially the same height above, the respective bases of the butts so as to allow said distribution butt and said at least one additional storage butt to fill and empty at substantially the same rate,
and wherein said openings receiving said inlet and said outlet are also at substantially the same level as said connection.

2. A system as set forth in claim 1 wherein at least one of the main distribution butt and the at least one additional storage butt has three openings for separately receiving said inlet, said outlet and said connection.

3. A system as set forth in claim 1 wherein at least one of the main distribution butt and the at least one additional storage butt has four openings for separately receiving said inlet, said outlet and two of said connections.

4. A system as set forth in claim 2 wherein said openings are spaced apart around a periphery of said butts.

5. A system as set forth in claim 3 wherein said butts are circular in cross-section and said openings are circumferentially spaced 90 degrees apart.

6. A system as set forth in claim 2 wherein said openings each comprise a universal connector socket capable of receiving either an inlet, an outlet or a connection.

7. A system as set forth in claim 2 further comprising a pump arranged within said main distribution butt to pump water from said outlet.

8. A system as set forth in claim 7 wherein said pump is powered by a mains electric power supply.

9. A system as set forth in claim 7 wherein said pump is powered by a battery.

10. A system as set forth in claim 7 wherein said pump comprises control means to adjust pump pressure.

11. A system as set forth in claim 1 wherein said connection comprises a radially extending connecting pipe.

12. A system as set forth in claim 11 wherein said connecting pipe comprises a stop tap operable to restrict or prevent flow.

13. A system as set forth in claim 1 wherein said outlet comprises a multi-way distribution unit.

14. A system as set forth in claim 1 comprising at least one stop-plug for closing off said openings.

15. A system as set forth in claim 1 further comprising an overflow pipe.

16. A system as set forth in claim 1 wherein the system comprises a filter arranged to filter water entering the system.

17. (canceled)

18. A water butt system comprising:
a main distribution butt having a base and a sidewall to define a container, a first opening in said sidewall to receive an outlet and at least one further opening in said sidewall which receives a fluid connection;
at least one additional storage butt having a base and a sidewall to define a container, and at least one opening in said sidewall which receives said connection;
a further opening in at least one of said main distribution butt and said at least one additional storage butt to receive an inlet;
wherein the base of said main distribution butt is at substantially the same level as the base of said at least one additional storage butt;
and said at least one further opening of said main distribution butt and said at least one opening in said sidewall of said at least one additional storage butt which receive said connection are proximate to and at substantially the same height above, the respective bases of the butts so as to allow said distribution butt and said at least one additional storage butt to fill and empty at substantially the same rate,
wherein said openings receiving said inlet and said outlet are also at substantially the same level as said connection.
and wherein at least one of the main distribution butt and the at least one additional storage butt has four openings which are circular in cross-section for separately receiving said inlet, said outlet and two of said connections and said openings are circumferentially spaced 90 degrees apart.

19. A system as set forth in claim 18 wherein said openings each comprise a universal connector socket capable of receiving either an inlet, an outlet or a connection.

20. A system as set forth in claim 19 further comprising a pump arranged within said main distribution butt to pump water from said outlet.

21. A system as set forth in claim 20 wherein said pump comprises control means to adjust pump pressure.

22. A system as set forth in claim 21 wherein said connection comprises a radially extending connecting pipe.

23. A water butt system comprising:
a main distribution butt having a base and a sidewall to define a container, a first opening in said sidewall to receive an outlet comprising a multi-way distribution unit and at least one further opening in said sidewall which receives a fluid connection said connection comprising a radially extending connecting pipe and a stop tap operable to restrict or prevent flow;
at least one additional storage butt having a base and a sidewall to define a container, and at least one opening in said sidewall which receives said connection;
a further opening in at least one of said main distribution butt and said at least one additional storage butt to receive an inlet;
a pump arranged within said main distribution butt to pump water from said outlet, wherein said pump comprises control means to adjust pump pressure;
an overflow pipe;
a filter arranged to filter water entering the system;
wherein the base of said main distribution butt is at substantially the same level as the base of said at least one additional storage butt;
and said at least one further opening of said main distribution butt and said at least one opening in said sidewall of said at least one additional storage butt which receive said connection are proximate to and at substantially the same height above, the respective bases of the butts so as to allow said distribution butt and said at least one additional storage butt to fill and empty at substantially the same rate,
wherein said openings receiving said inlet and said outlet are also at substantially the same level as said connection.
and wherein at least one of the main distribution butt and the at least one additional storage butt has four openings for separately receiving said inlet, said outlet and two of said connections.
